(19) United States
(12) Patent Application Publication
(10) Pub. No.: US 2025/0297372 A1
(43) Pub. Date: Sep. 25, 2025

(54) SULFUR DIOXIDE ELECTROLYZER WITH IMPROVED SULFURIC ACID CONCENTRATION FORMATION AND METHOD OF OPERATION

(71) Applicant: Peregrine Hydrogen Inc., Santa Cruz, CA (US)

(72) Inventors: Matthew Shaner, Santa Cruz, CA (US); Stefan Omelchenko, Santa Cruz, CA (US); Ruperto G. Mariano, Santa Cruz, CA (US)

(73) Assignee: Peregrine Hydrogen Inc., Santa Cruz, CA (US)

(21) Appl. No.: 19/087,106

(22) Filed: Mar. 21, 2025

Related U.S. Application Data
(60) Provisional application No. 63/568,944, filed on Mar. 22, 2024.

(51) Int. Cl. C25B 1/04; C05B 1/00; C25B 9/19; C25B 13/08; C25B 15/08

(52) U.S. Cl. CPC C25B 1/04; C05B 1/00; C25B 9/19; C25B 13/08; C25B 15/083

(57) ABSTRACT

A method can include: introducing sulfur dioxide in an anolyte flow path of an electrolyzer; optionally, introducing water in the catholyte flow path of the electrolyzer; operating the electrolyzer; optionally: processing the products; and optionally: using the products. In some variants of the method, the amount of water introduced can be balanced such as to achieve a target sulfuric acid concentration.

### CROSS-REFERENCE TO RELATED APPLICATIONS

This application claims the benefit of U.S. Provisional Application No. 63/568,944 filed 22 Mar. 2024, which is incorporated in its entirety by this reference.

### TECHNICAL FIELD

This invention relates generally to the sulfur dioxide electrolysis field, and more specifically to a new and useful system and method in the sulfur dioxide electrolysis field.

### BRIEF DESCRIPTION OF THE FIGURES

FIG. 1 is a schematic representation of an exemplary method for SO₂ electrolysis.

FIG. 2 is a schematic representation of an exemplary electrolyzer.

FIG. 3 is a schematic representation of an exemplary electrolyzer.

FIG. 4 is an illustrative example of operating a sulfur dioxide electrolyzer.

### DETAILED DESCRIPTION

The following description of the embodiments of the invention is not intended to limit the invention to these embodiments, but rather to enable any person skilled in the art to make and use this invention.

### 1. Overview

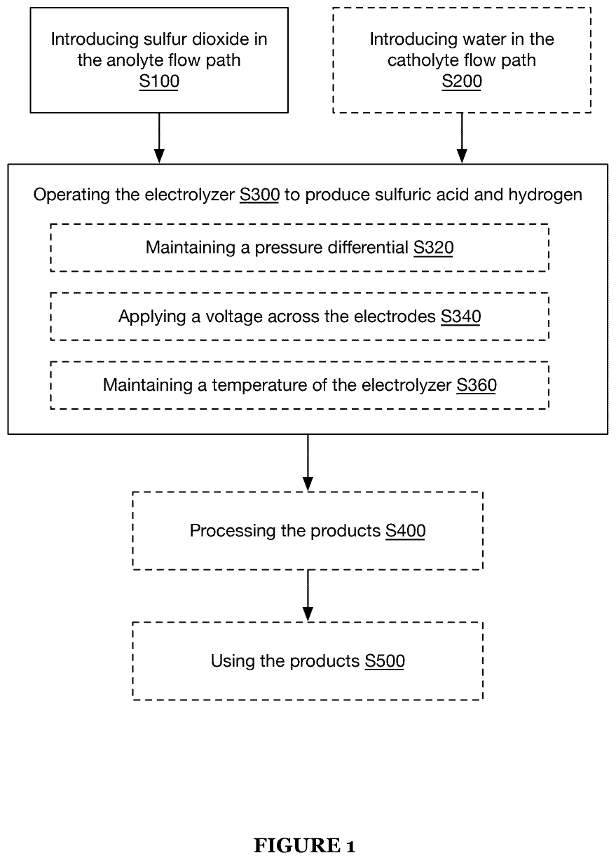

As shown in FIG. 1, a method can include: introducing sulfur dioxide in an anolyte flow path of an electrolyzer S100; optionally, introducing water in the catholyte flow path of the electrolyzer S200; operating the electrolyzer S300; optionally: processing the products S400; and optionally: using the products S500.

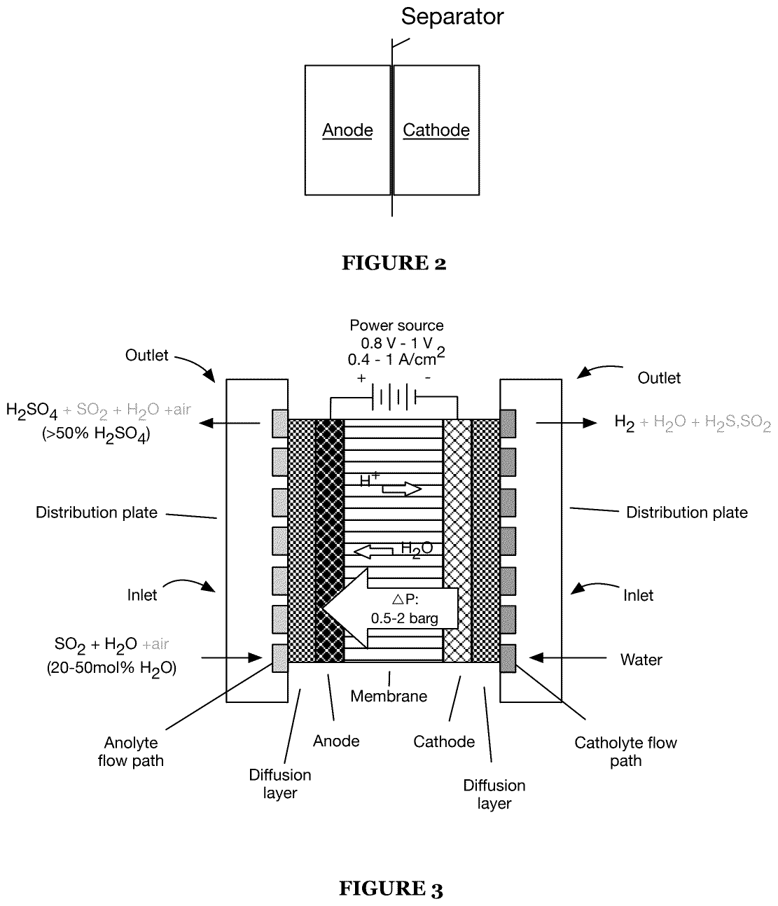

As shown in FIG. 2, an electrolyzer can include an anode, a cathode, and a separator. As shown for example in FIG. 3, the anode can include an anolyte, an electrode, an anolyte reaction region, an anolyte inlet, an anode distribution plate (e.g., defining the anolyte reaction region), an (oxidized) anolyte outlet, a diffusion layer, and/or any suitable components. As shown for example in FIG. 3, the cathode can include a catholyte, an electrode, a catholyte reaction region, a catholyte inlet, a cathode distribution plate (e.g., defining the catholyte reaction region), a (reduced) catholyte outlet, a diffusion layer, and/or any suitable components. However, the electrolyzer can include any suitable components.

Embodiments of the system and/or method preferably facilitate and/or leverage the electrochemical oxidation of sulfur dioxide to sulfuric acid and electrochemical reduction of water (e.g., protons) to hydrogen. Examples of applications of the sulfuric acid and/or hydrogen include: chemical manufacturing, pharmaceutical manufacturing, ore refining, oil refining, ore extractions (e.g., recovery of nickel from nickel laterite ore), fertilizer production (e.g., to form ammonium sulfates, ammonium phosphates, etc.), metal processing, paper and pulp, automotive (e.g., for lead batteries, fuel cells, etc.), and/or any suitable applications can be performed using the sulfuric acid and/or hydrogen.

### 2. Illustrative Examples

In an illustrative example, an electrolyzer can include an anolyte flow path operable to receive sulfur dioxide and optionally water and a catholyte flow path operable to receive water. The (total) amount of water introduced to the electrolyzer is preferably controlled (e.g., balanced) such that the electrolyzer produces sulfuric acid at concentrations above 50 wt % (e.g., 55 wt %, 60 wt %, 62 wt %, 65 wt %, 68 wt %, 70 wt %, 71 wt %, 72 wt %, 73 wt %, 75 wt %, etc.). The electrolyzer can be operated at a voltage of approximately 0.9 V and a current density between 0.4 A/cm² and 1 A/cm². Additionally, the electrolyzer can be configured to achieve a pressure differential of at least 0.1 barg between the cathode and anode (with a greater pressure typically but not necessarily on the cathode side) which can promote water from the cathode being forced through a membrane of the electrolyzer to the anode.

In a second illustrative example, a method can include: introducing sulfur dioxide at an anolyte flow path of an electrolyzer with 20-50 mol % of water, optionally introducing water at a catholyte flow path, and controlling (e.g., balancing) the amount of water introduced to the electrolyzer to produce sulfuric acid with a concentration above 50 wt % (e.g., greater than or equal to 55 wt %, greater than or equal to 57 wt %, greater than or equal to 60 wt %, greater than or equal to 62 wt %, greater than or equal to 64 wt %, greater than or equal to 65 wt %, greater than or equal to 67 wt %, greater than or equal to 70 wt %, greater than or equal to 72 wt %, greater than or equal to 73 wt %, etc.). The method can additionally include: maintaining a pressure differential (e.g., approximately 1.5 barg, greater than 0.5 barg, greater than 0.1 barg, etc. where the differential pressure can depend on a thickness of the separator) such that water at the cathode side is forced through a membrane and/or such that a counter force hindering or limiting SO₂ cross-over through the membrane, applying a voltage (e.g., approximately 0.9 V; 0.4-1 A/cm²) to electrically induce oxidation of the sulfur dioxide and reduction of the water, and maintaining a temperature of the electrolyzer (e.g., 60° C.-200° C. where the temperature can depend on the membrane material).

### 3. Technical Advantages

Variants of the technology can confer one or more advantages over conventional technologies.

First, variants of the technology can enable improved control over sulfuric acid concentration output from a sulfur dioxide depolarized electrolyzer through improved operational parameters. For instance in examples utilizing nafion membranes (e.g., a polymer of tetrafluoroethylene with perfluoro ether sulfonate pendant groups; ethanesulfonyl fluoride; 2-[1-[difluoro-[(trifluoroethenyl)oxy]methyl]-1,2,2,2-tetrafluoroethoxy]-1,1,2,2,-tetrafluoro-, with tetrafluoroethylene; tetrafluoroethylene-perfluoro-3,6-dioxa-4-methyl-7-octenesulfonic acid copolymer), the electrolyzer can achieve sulfuric acid concentrations exceeding 60% (e.g., 61%, 62%, 64%, 67%, 70%, 71%, 73%, 75%, etc. where % can refer to w/w %, w/v %, v/v %, v/w %, etc.). In this example, the electrolyzer can achieve such sulfuric acid concentrations through tuning of operational parameters such as temperature, water inclusion (e.g., total amount of water introduced in the electrolyzer relative to the electrolyzer, location of water introduction i.e., cathode vs anode, etc.), differential pressure (e.g., between cathode and anode), total pressure, current density, voltage (e.g., overpotential), and/or other operational parameters. In other examples, non-nafion membranes can similarly enable higher concentrations of sulfuric acid (e.g., meeting or exceeding 60 wt % sulfuric acid); for instance, by enabling further control over operational parameters.

Second, variants of the technology can provide enhanced efficiency and/or environmental benefits in sulfuric acid and hydrogen production processes. In one example, by generating higher concentration sulfuric acid directly from the electrolyzer, these examples of the technology can eliminate the need for subsequent concentration steps (e.g., water evaporation processes), which can be energy-intensive. The reduction and/or elimination of these concentration steps can reduce the overall energy consumption of the sulfuric acid production process, leading to reduced operational costs and a smaller carbon footprint. This direct production of concentrated sulfuric acid can, for instance, make the process more suitable for industrial applications (e.g., enable direct integration with existing processes, able to integrate with processes that require higher sulfuric acid concentrations, enable cheaper shipping as less water is shipped).

However, further advantages can be provided by the system and method disclosed herein.

### 4. Electrolyzer

As shown in FIG. 2, an electrolyzer can include an anode, a cathode, and a separator. As shown for example in FIG. 3, the anode can include an anolyte, an electrode, an anolyte reaction region, an anolyte inlet, an anode distribution plate (e.g., defining the anolyte reaction region), an (oxidized) anolyte outlet, a diffusion layer, and/or any suitable components. As shown for example in FIG. 3, the cathode can include a catholyte, an electrode, a catholyte reaction region, a catholyte inlet, a cathode distribution plate (e.g., defining the catholyte reaction region), a (reduced) catholyte outlet, a diffusion layer, and/or any suitable components. However, the electrolyzer can include any suitable components.

The electrolyzer preferably functions to oxidize sulfur dioxide to sulfuric acid (and/or sulfur trioxide) with concurrent reduction of protons (e.g., H⁺, from water, hydronium, etc.). However, the electrolyzer can additionally or alternatively function (e.g., using one or more alternative anolytes and/or catholytes).

The electrolyzer can be a unicell electrolyzer and/or a multicell electrolyzer (e.g., with a plurality of cells in parallel).

The electrolyzer cell (e.g., components thereof such as distribution plates, total spatial extent of anolyte or catholyte flow paths, membrane, electrodes, anode, cathode, diffusion layer, etc.) can have a spatial extent between about 10 cm² and 1 m² (e.g., 25 cm², 50 cm², 100 cm², 250 cm², 500 cm², 1000 cm², 2500 cm², 5000 cm², 10 dm², 25 dm², 50 dm², 100 dm², 250 dm², 500 dm², 1000 dm², values or ranges therebetween, etc.). However, the spatial extent can be less than 10 cm² or greater than 1 m².

The anode preferably functions to oxidize an anolyte. The anolyte is preferably sulfur dioxide. However, other suitable anolytes may be realized (e.g., SOₓ). The anolyte can be provided in the gas phase (e.g., gaseous SO₂), liquid phase (e.g., condensed SO₂, SO₂ dissolved in water, SO₂ dissolved in sulfuric acid, SO₂ dissolved in sulfurous acid, etc.), and/or in any suitable phase (e.g., dissolved in a solvent). In variants where the anolyte is provided in the gas phase, the anolyte can optionally include one or more carrier gases (e.g., inert gases such as inert to electrolysis like nitrogen, oxygen, argon, air, carbon dioxide, neon, methane, krypton, etc.). For instance, the anolyte composition can range from pure sulfur dioxide gas (e.g., 100% SO₂) to about 10% SO₂(by mass, by volume, by stoichiometry) with the remainder carrier gas. In some variants, the anolyte (and/or oxidized anolyte) can impart or improve an electrical conductivity to a solvent the anolyte is dissolved in (e.g., a solvent provided with the anolyte, a solvent from the catholyte, etc.).

The distribution plate (e.g., bipolar plates, flow field plate, etc.) can be made from (e.g., include) carbon material(s) (e.g., graphite; composite such as polymer matrix including thermoset resins like epoxy resin, phenolic resin, furan resin, vinyl ester, etc.; thermoplastic resin such as polypropylene, polyethylene, poly(vinylidene fluoride), etc.; etc. with a filler such as graphite powder, graphite flake, exfoliated graphite, coke-graphite, carbon nanotubes, carbon fiber, cellulose fiber, cotton flock, etc.; etc.), metal-composite (e.g., layered graphite, polycarbonate plastic, and stainless steel), metallic plates (e.g., stainless steel, aluminium, titanium, nickel, etc. optionally including a coating such as metal carbide, metal nitride, noble metal, metal oxide, catalyst, graphite, conductive polymer, etc.), and/or using any suitable material. The distribution plate can be solid (e.g., with cutouts, trenches, etc. defining an anolyte flow path; with structures protruding from a broad face of the distribution plate defining an anolyte flow path; etc. and through-holes defining inlets and/or outlets), porous (e.g., with a region analogous to the anolyte flow path where the anolyte primarily undergoes oxidation, where the distribution plate can act as a diffusion layer, etc.), and/or can have any suitable structure.

The diffusion layer can function to allow fluids (e.g., gases, liquids, solutes dissolved in the fluid, etc.) to diffuse to an electrode or catalyst layer (e.g., where the anolyte or species thereof can undergo oxidation). The diffusion layer can be made from porous carbon paper, carbon cloth, graphitized carbon paper, and/or can be made from any suitable material(s). The diffusion layer is typically between about 100-1000 μm thick. However, the diffusion layer can be thicker than 1000 μm or thinner than 100 μm.

The anode electrode can include (e.g., be made from): platinum, gold, graphite, palladium, ruthenium, rhenium, iridium, rhodium, nickel, iron, combinations thereof (e.g., platinum-gold alloys), and/or any suitable electrode material can be used. In some variants, the anode electrode can be coated with the electrode material (e.g., where the coating material can act as a catalyst, protectant, etc.) and/or a catalyst material. Examples of catalyst materials include metal oxides (e.g., ruthenium oxide, palladium oxide, iridium oxide, titanium oxide, nickel oxide, iron oxide, etc.), nanoparticles (e.g., of an electrode material), carbon-based materials (e.g., carbon nanotubes, graphene, graphite, etc.), metal-organic frameworks (e.g., MOFs), polymer(s), alloys (e.g., Pt/C, PtRu/c, PtCo/C, etc.), combinations thereof, and/or any suitable materials. A catalyst loading is preferably between about 0.01 mg/cm² and 10 mg/cm². However, the catalyst loading can be less than 0.01 mg/cm² or greater than 10 mg/cm².

The anode catalyst preferably has a high specific surface area (e.g., a specific surface area greater than about 10 m²/g, 15 m²/g, 20 m²/g, 25 m²/g, 50 m²/g, 75 m²/g, 100 m²/g, 150 m²/g, 200 m²/g, 250 m²/g, 500 m²/g, 1000 m²/g, etc.). However, the anode catalyst can have a low specific surface area (e.g., <10 m²/g), different specific surface area for different surfaces it is disposed on (e.g., a high specific surface area on an electrode and a low specific surface area on walls or surfaces defining the anolyte reaction region, a low specific surface area on an electrode and a high specific surface area on walls or surfaces defining the anolyte reaction region, a higher specific surface area on an electrode than on walls or surfaces defining the anolyte reaction region, a lower specific surface area on an electrode than on walls or surfaces defining the anolyte reaction region, etc.), and/or can have any suitable specific surface area.

The catalyst can form a coating (e.g., conformal coating, bumpy coating, porous coating, etc.), can include particles (e.g., nanoparticles such as nanospheres, nanorods, nanotubes, nanostars, nanoshells, nanopolyhedra, etc.; mesoparticles; microparticles; etc. such as hollow particles, porous particles, solid particles, etc.) that can be deposited on a surface, and/or can have any suitable structure (e.g., engineered structure).

In some variants, catalyst can be disposed on (e.g., deposited on) surfaces of the anolyte reaction region (e.g., in addition to or as an alternative to coating or being the electrode). For instance, the distribution plate can be made of the catalyst, the distribution plate can include structures made from the catalyst the define the anolyte reaction region, walls or surfaces defining the anolyte reaction region can include catalyst, and/or the catalyst can otherwise be disposed on surfaces of the anolyte reaction region.

The cathode preferably functions to reduce a catholyte species. The catholyte is typically protons (usually provided as hydronium ions, dissolved in water, etc.) resulting in a reduced catholyte species of hydrogen (H₂) or isotopes thereof. The catholytes are typically provided dissolved in a solvent (e.g., water). However, the catholytes can be provided in gas phase, liquid phase, and/or in any suitable phase (e.g., plasma). In some variants, the catholyte can crossover the membrane (e.g., separator) and into the anolyte reaction region.

In variants of the technology that use water (or species derived therefrom such as hydronium) as the catholyte, the water can be introduced in a catholyte inlet, an anolyte inlet (e.g., where water from the anode side of the separator crosses over the separator and into the cathode), and/or from a combination thereof. As a first specific example, the anolytes can be hydrated (e.g., a gas of the anolytes can be provided with water vapor). For instance, a relative humidity (e.g., the amount of atmospheric water present relative to the amount of atmospheric water that would be present if the atmosphere were saturated with water such as at the anolyte inlet, at the electrolyzer operation temperature, etc.) of the anolyte can be between about 10% and 100% (e.g., 20%, 25%, 30%, 33%, 40%, 50%, 55%, 60%, 70%, 75%, 80%, 90%, 95%, values or ranges therebetween, etc.). In a first variation of the first specific example, water can only be introduced into the electrolyzer from the anode side (e.g., with the anolyte). In a second variation of the first specific example, water can, in addition to with the anolyte, be introduced into the cathode side of the electrolyzer (where a total amount of water introduced can be approximately stoichiometric for the oxidation of sulfur dioxide and reduction of water, can include sufficient water to hydrate the membrane in addition to the stoichiometric water, etc.). In a second specific example, sulfur dioxide can be dissolved in water (e.g., liquid water) such as at a concentration up to about 97% (v/v). In a first variation of the second specific example, water can only be introduced into the electrolyzer from the anode side (e.g., with the anolyte, as the solvent). In a second variation of the second specific example, water can additionally be introduced from the cathode side of the electrolyzer. In a third specific example, water can be introduced from the catholyte side of the electrolyzer (e.g., as steam, as liquid water, as water vapor with a carrier gas such as at a relative humidity between about 10% and 100%, etc.). In a first variation of the third specific example, water can only be introduced from the cathode side of the electrolyzer (e.g., where water used in the anode half-reaction comes from water that crosses over the separator or membrane). In a second variation of the third specific example, water can additionally be introduced from the anode side of the electrolyzer (where a total amount of water introduced can be approximately stoichiometric for the oxidation of sulfur dioxide and reduction of water, can include sufficient water to hydrate the membrane in addition to the stoichiometric water, etc.). However, water can be introduced into the electrolyzer in any manner. Using close to (e.g., exactly, exceeding by at most about 30%, etc.) stoichiometric amounts of water is preferred to achieve high concentrations of sulfuric acid. However, close to stoichiometric amount may not be possible in all variants (e.g., may lead to insufficient membrane performance resulting from dehydration of the membrane, requiring higher voltages and/or current densities, etc.), in which case the amount of water is preferably sufficient to hydrate the membrane (in addition to perform the reaction). However, any quantity of water can be used.

The distribution plate (e.g., bipolar plates, flow field plate, etc.) can be the same as and/or different from the anode distribution plate. For instance, the distribution plate can be made in the same manner as, from the same material as, have the same dimensions as, a catholyte reaction region (or catholyte flow path) that is the same as (e.g., mirror image of, has the same structure as, etc.) the anolyte reaction region (or anolyte flow path), and/or can otherwise have any suitable distribution plate as described for an anode distribution plate.

The cathode diffusion layer can be any suitable anode diffusion layer (e.g., as described above). The cathode diffusion layer can be the same as and/or different from the anode diffusion layer.

The cathode electrode can include (e.g., be made from, be coated with, etc.): platinum, gold, carbon (e.g., graphite, carbon black, etc.), palladium, ruthenium, rhenium, iridium, rhodium, nickel, iron, titanium, combinations thereof (e.g., platinum-gold alloys), and/or any suitable electrode material can be used.

In some variants, the cathode electrode (e.g., a substrate, support layer, etc. preferably with high electrical conductivity) can be coated with the electrode material (e.g., where the coating material can act as a catalyst, protectant, etc.) and/or a catalyst material (e.g., electrocatalyst). Examples of catalyst materials include metal oxides (e.g., ruthenium oxide, palladium oxide, iridium oxide, titanium oxide, nickel oxide, iron oxide, etc.), nanoparticles (e.g., of an electrode material), carbon-based materials (e.g., carbon nanotubes, graphene, graphite, etc.), metal-organic frameworks (e.g., MOFs), polymer(s), alloys (e.g., Pt/C, PtRu/c, PtCo/C, etc.), combinations thereof, and/or any suitable materials. A catalyst loading is preferably between about 0.01 mg/cm² and 10 mg/cm². However, the catalyst loading can be less than 0.01 mg/cm² or greater than 10 mg/cm².

The cathode catalyst preferably has a high specific surface area (e.g., a specific surface area greater than about 10 m²/g, 15 m²/g, 20 m²/g, 25 m²/g, 50 m²/g, 75 m²/g, 100 m²/g, 150 m²/g, 200 m²/g, 250 m²/g, 500 m²/g, 1000 m²/g, etc.). However, the cathode catalyst can have a low specific surface area (e.g., <10 m²/g), different specific surface area for different surfaces it is disposed on, and/or can have any suitable specific surface area.

The catalyst can form a coating (e.g., conformal coating, bumpy coating, porous coating, etc.), can include particles (e.g., nanoparticles such as nanospheres, nanorods, nanotubes, nanostars, nanoshells, nanopolyhedra, etc.; mesoparticles; microparticles; etc. such as hollow particles, porous particles, solid particles, etc.) that can be deposited on a surface, and/or can have any suitable structure (e.g., engineered structure).

The catholyte reaction region (e.g., catholyte flow path) can be analogous to any anolyte reaction region as described above. For instance, the catholyte reaction region can be the same as and/or different from the anolyte reaction region. The catholyte reaction region is preferably a mirror image of the anolyte reaction region (e.g., mirror image across the membrane). However, the catholyte reaction region and anolyte reaction region can otherwise be related (e.g., preferably, but not necessarily, in a manner that results in a closed system where anolyte, oxidized anolyte, catholyte, and reduced catholyte are retained within the electrolyzer).

The electrolyzer is preferably operated with a differential pressure between the cathode and the anode. The differential pressure can depend on the membrane, on where water is introduced, the operating temperature, materials of the electrolyzer, and/or suitable properties of the electrolyzer or components thereof. Typically, the cathode is maintained at the greater pressure relative to the anode which can be beneficial for hindering crossover of sulfur dioxide or other sulfur compounds across the separator. However, the anode can be maintained at greater pressures relative to the cathode. The differential pressure is typically between about 5 and 100 bar (e.g., 10 bar, 15 bar, 20 bar, 25 bar, 30 bar, 40 bar, 50 bar, 75 bar, 80 bar, 90 bar, values or ranges therebetween, etc.). However, the differential pressure can be any suitable pressure.

In some variants, particularly but not exclusively for non-nafion membranes, substantially no differential pressure can be used (e.g., differential pressure ≤0.5 Bar, ≥0.25 Bar, etc.).

The electrolyzer can be operated under pressure, where in variants with a differential pressure the pressurized operation can refer to an absolute pressure of a lower pressure (or higher pressure) electrode of the electrolyzer. The pressurized operation is typically limited by material compatibility of components of the electrolyzer (e.g., reactivity of components to sulfuric acid under pressure and temperature). However, the pressurized operation can otherwise be limited. Examples of pressures that can be used for pressurized operation include (but are not limited to): 2 bar, 3 bar, 5 bar, 10 bar, 15 bar, 20 bar, 30 bar, 50 bar, 75 bar, 100 bar, 125 bar, 150 bar, 200 bar, 250 bar, 300 bar, 500 bar, 1000 bar, and/or other suitable pressures.

The separator (e.g., membrane, diaphragm) preferably functions to shuttle ions (e.g., protons) and/or molecules (e.g., solvent molecules such as water) between the anode and the cathode while hindering (e.g., preventing) the anolyte, catholyte, oxidized anolyte products, reduced catholyte products, and/or other species (e.g., electrons, electricity, etc.) from crossing the separator and/or electrically insulating the anode and cathode (from one another). The separator is preferably arranged between the anolyte reaction region and the catholyte reaction region. However, the separator can be arranged in any suitable manner (e.g., a plurality of separators can be used).

The separator thickness is typically between about 10 μm and 500 μm (e.g., to optimize for selectivity in hindering anolyte or catholyte crossover and electrical conductivity). However, the separator can be thinner than 10 μm or thicker than 500 μm.

The separator can be made from fluoropolymers (e.g., nafion, fumapem, fumasep, aquivion®, etc. such as Nafion 112, Nafion 115, Nafion 117, Nafion NR211, Nafion NR212, Nafion 1110, Nafion 324, Nafion 424, Nafion 438, Nafion 551, Nafion NE1035, Nafion HP, Nafion XL, fiber reinforced Nafion, etc.), polybenzimidazole (PBI) membranes (e.g., doped with phosphoric acid, sulfuric acid, etc. such as Celtec®-L, Celtec®-P, Celazole®, etc.), sulfonated polybenzimidazole (s-PBI such as copolymers of poly[2,2′-(m-phenylen)-5,5′-bisbenzimidazole] with 3,3′-diaminobenzidine (DABD), 4,4′-oxybis(benzoic acid) (OBBA), 5-sulfoisophthalic acid (SIPA) and 4,8-disulfonyl-2,6-naphthalenedicarboxylic acid (DSNDA), etc.), sulfonated Diels-Alder poly(phenylene) membranes (SDAPP such as polymers formed by Diels-Alder polymerization of 1,4-bis(2,4,5-triphenylcyclopentadienone)benzene and 1,4-diethynylbenzene followed by sulfonation of the resulting polymer), sulfonated poly(ether sulfone)s, silicon carbide (e.g., saturated with phosphoric acid, sulfuric acid, etc.), polytetrafluoroethylene (PTFE), glass (e.g., glass fiber membrane), aromatic polymers (e.g., PEEK), protic ionic liquids, protic ionic plastic crystals, ionomers (e.g., perfluorosulfonic acid (PFSA), PFSA-silica composites, Aciplex™, Flemion™, etc.), composite membranes (e.g., composites of glass and one or more polymer such as polymers used in the production of other membranes from the above list, composites of nafion and silica, composites of nafion and titania, composites of nafion and zirconium phosphate, etc.), and/or using any suitable separator. For example, a perfluorosulfonic acid/PTFE copolymer can be used as the separator.

Variants that use a nafion membrane can run into performance issues as nafion (and some other membrane materials) require water for ionic conduction. These can limit the operation conditions (e.g., amount of introduced water, operation temperature, etc.) and thus can set limits on the achievable sulfuric acid concentration from the electrolyzer. However, the inventors have found that nafion membranes can overcome these limitations to achieve high sulfuric acid concentrations (e.g., ≥60% such as 64%, 67%, 70%, 71%, 73%, etc.). For example, by operating a with a current density between 0.4 and 1 A/cm² at 0.9V, at a temperature of approximately 80° C., and with substantially all water added from the anolyte side of the electrolyzer can achieve high sulfuric acid concentrations (without sacrificing, reducing, etc. electrolyzer lifetime; without requiring significantly greater amounts of energy; etc.).

Variants that use non-nafion membrane materials (e.g., PBI, s-PBI, SDAPP, SiC, PTFE, glass, etc.) can provide a technical advantage as they enable operation of the electrolyzer without requiring (excess) water (e.g., can operate using stoichiometric amounts of water for the sulfur dioxide oxidation reaction, i.e., 2 moles of water per mole of sulfur dioxide according to SO₂+2H₂→H₂SO₄+H₂), thereby facilitating formation of high concentrations of sulfuric acid (e.g., concentrations exceeding about 60%, etc. where the percent can refer to a weight percent, volume percent, stoichiometric percent, etc.) as almost no excess water can be present. Relatedly, these variants can enable higher temperatures of operation (e.g., at temperatures exceeding 80° C. such as 85° C., 90° C., 95° C., 100° C., 105° C., 110° C., 115° C., 120° C., etc.), which can be beneficial for lowering an operating voltage, improving reaction kinetics and/or thermodynamics, improved ionic conductivity, and/or can otherwise be beneficial. To improve contact, improve wettability, reduce current density, reduce overpotential, and/or for other reasons, additional water beyond stoichiometric amounts can be included in the electrolyzer, where the amount of excess can balance the operation of the electrolyzer with the resultant sulfuric acid concentration. In some variations, the membrane can be configured (e.g., thickness, porosity, tortuosity, etc.) and/or other aspects of the electrolyzer (e.g., flow fields, operating voltage, current density, etc.) such that controlled amounts (e.g., only stoichiometric amounts, a quantity that enables the reaction and controlled sulfuric acid concentrations, etc.) of water are able to pass from the catholyte to the anolyte thereby controlling the amount of water in the oxidized anolyte stream (and thus the resultant sulfuric acid concentration). In these variations, water is typically only added from the cathode side of the electrolyzer. However, water can be added with the anolyte in these variations (e.g., less water can crossover the membrane).

In some variants, a blended and/or combined separator can be used. For instance, a combination of a nafion separator and a non-nafion separator can be used (e.g., where the nafion separator is preferably on a cathode facing side of the separator).

In some variants, the separator can be saturated with a proton source (e.g., acid such as sulfuric acid, phosphoric acid, etc.) which can result in enhanced ionic conductivity.

An ionic conductivity (e.g., conductivity to permit flow of protons, hydrogen ions, hydrogen cations, sulfate anions, etc.) of the separator is preferably at least about 0.1 S/cm (e.g., 0.2, 0.5, 0.8, 1, 1.2, 1.5, 2, 2.5, 3, 5, values or ranges therebetween, etc.). However, the separator can have any suitable ionic conductivity. The ionic transport can be ballistic, diffusive, driven (e.g., via a pump), and/or can have any suitable ion transport mechanism.

The electrolyzer preferably operates at a current density of between about 0.4 and 1 A/cm² (e.g., 0.4 A/cm², 0.45 A/cm², 0.5 A/cm², 0.55 A/cm², 0.6 A/cm², 0.75 A/cm², 0.8 A/cm², 0.9 A/cm², etc.). However, the electrolyzer can operate at any suitable current density.

The electrolyzer preferably operates at an electric potential that is approximately 0.9 V (e.g., 0.87-0.95 V). However, the electrolyzer can operate under a higher electric potential (e.g., with increased energy cost) and/or lower electric potential (e.g., with a reduced sulfuric acid output concentration).

The electrolyzer operating temperature typically depends on the membrane. However, the operating temperature can additionally or alternatively depend on the electrolyzer materials (e.g., material compatibility with sulfuric acid at elevated temperature), the electric potential, current density, catalyst(s), and/or other suitable properties of the electrolyzer. The electrolyzer operating temperature is preferably between about 60° C. and 200° C. (e.g., 70° C., 75° C., 80° C., 85° C., 90° C., 100° C., 105° C., 110° C., 120° C., 140° C., etc.). For instance, when a nafion membrane is used, the operating temperature is preferably between about 60° C. and 90° C. In another example, when a non-nafion membrane is used, the operating temperature can be between 100 and 180° C. However, any suitable temperature can be used with any suitable membrane. In some variants, evaporation of water (e.g., from the sulfuric acid output) can be used to cool, adjust, maintain, and/or otherwise control a temperature of the electrolyzer (e.g., with a potential added benefit of concentrating the sulfuric acid).

### 5. Method

As shown in FIG. 1, the method can include: introducing sulfur dioxide in an anolyte flow path of an electrolyzer S100; optionally, introducing water in the catholyte flow path of the electrolyzer S200; operating the electrolyzer S300; optionally, processing the products S400; and optionally, using the products S500. The method is typically performed using an electrolyzer (e.g., as described above). However, other suitable electrochemical system(s) can be used. The method can be performed continuously, in batches, in real time (e.g., in response to a request), periodically, and/or any other timing.

The method preferably functions to operate an electrolyzer to produce sulfuric acid and hydrogen gas. The resulting sulfuric acid concentration from performing variants of the method preferably produce higher concentrations of sulfuric acid at the outlet of the electrolyzer (compared to traditional operating conditions). For instance, the method can result in sulfuric acid concentrations exceeding 55 wt %, exceeding 60 wt %, exceeding 62 wt %, exceeding 65 wt %, exceeding 70 wt %, exceeding 71 wt %, exceeding 75 wt %, exceeding 80 wt %, and/or other suitable concentrations. In some variants (particularly for electrolyzers that use nafion separators, but potentially other variants as well), there can be an upper limit for the sulfuric acid concentration (e.g., to avoid excessively high voltages, to mitigate a risk of degradation of the electrolyzer or components thereof, etc.). For instance, an upper limit of sulfuric acid concentration can be 75 wt %, 80 wt %, 85 wt %, 90 wt %, 95 wt %, and/or other suitable upper limit.

The method can receive sulfur dioxide (SO₂), water, additives, and/or any other material(s). The method can produce hydrogen (H₂), sulfuric acid (H₂SO₄), and/or any other product.

In a preferred example, the method can function to perform the chemical reaction: SO₂+2H₂O→H₂SO₄+H₂. In this example, the anode half reaction can be: SO₂+2H₂O→H₂SO₄+2H⁺+2e⁻. Similarly, in this example, the cathode half reaction can be: 2H⁺+2e⁻␣H₂. However, other side reactions can occur and/or the electrolyzer can perform other reactions.

Introducing sulfur dioxide in an anolyte flow path of an electrolyzer S100 functions to introduce an anolyte to the electrolyzer so that it can be oxidized to produce a product.

S100 can be performed by pumps (e.g., centrifugal pumps, diaphragm pumps, peristaltic pumps, etc.), valves (e.g., needle valves, solenoid valves, check valves, etc.), microfluidic devices, flow manifolds, porous flow fields, and/or any other mechanisms (e.g., that enable or promote fluid flow or transport).

S100 can be performed continuously, intermittently, synchronously (e.g., contemporaneously, simultaneously, with a predetermined timing relative to, etc.) with other steps (for example, synchronously with S200 or S300), asynchronously of other steps, and/or with any other timing pattern.

The anolyte is preferably introduced in an anolyte flow path (e.g., a region of the electrolyzer for containing the anolyte). The anolyte flow path can be in fluid connection with an anode and/or with a membrane (sometimes also referred to as a separator). The anolyte flow path can be a flow field, porous plate, and/or any other structure.

The anolyte is preferably SO₂. The sulfur dioxide is preferably in the gas phase. However, the sulfur dioxide can additionally or alternatively be in the liquid phase and/or dissolved in a solvent (e.g., water, oleum, etc.).

The anolyte can optionally include water, a carrier fluid, additives, and/or other suitable materials. In variants where the anolyte includes water, H₂O is preferably in gas phase (e.g., as steam). However, water can be introduced in liquid phase and/or any suitable phase. H₂O can be introduced with sulfur dioxide through the same or different manifolds or inlets. The sulfur dioxide-water mix can be a single phase (e.g., gas mixture, liquid mixture, etc.) or a plurality of phases (e.g., gaseous SO₂ and liquid H₂O, where the SO₂ can be dissolved in the water within the anolyte flow path). In a first example, the sulfur dioxide-water mix can be mixed prior to introducing into the electrolyzer. In a second example, the sulfur dioxide and water can be mixed in the electrolyzer by introducing each substance in separate streams (e.g., separate inlets)). The sulfur dioxide-water mix can have a water concentration between 0 mol % and 80 mol % or any range or value therebetween (ex: 5 mol % water, 10 mol % 20 mol % water, 25 mol % water, 30 mol % water, 35 mol % water, 35 mol % water, 40 mol %, water, 45 mol % water, 50 mol % water, 55 mol % water, 60 mol % water, 70 mol % water, 80 mol % water, values or ranges therebetween, etc.).

In a one example, S100 can include introducing liquid water and gaseous sulfur dioxide into the anolyte flow path (e.g., as a two-phase anolyte). In a variation of the one example, SO₂ can be dissolved in water by bubbling SO₂ through the water using a diffuser or sparger prior to introducing to the electrolyzer. In a second specific example, S100 can include introducing dry gaseous sulfur dioxide into the anolyte flow path (e.g., 100% SO₂, SO₂ with a carrier gas, etc.). In a third specific example, S100 can include introducing gaseous sulfur dioxide with a relative humidity between 10 and 100%.

In variants where the anolyte includes a carrier fluid (e.g., inert gas, carrier gas, etc.) the anolyte can include between 0 mol %-90 mol% carrier fluid (or any range or value therebetween such as o mol %, 1 mol %, 5 mol %, 10 mol %, 20 mol %, 30 mol %, 40 mol %, 50 mol %, 60 mol %, 70 mol %, 80 mol %, 90 mol %). Examples of carrier fluids include but are not limited to: nitrogen, oxygen, argon, air, neon, methane, krypton, helium, and/or xenon.

The sulfur dioxide can be received (e.g., from a third party, etc.), produced (e.g., by combustion or roasting of a sulfur-containing precursor such as described in U.S. patent application Ser. No. 18/633,051 titled ‘SULFUR DIOXIDE DEPOLARIZED ELECTROLYSIS AND ELECTROLYZER THEREFOR’ filed 11 Apr. 2024 which is incorporated in its entirety by this reference, where heat from the sulfur dioxide production can optionally be used in a downstream process such as sulfuric acid concentrating), and/or otherwise obtained.

However, introducing sulfur dioxide in an anolyte flow path of an electrolyzer S100 may be otherwise performed.

Optionally, introducing water in the catholyte flow path of the electrolyzer S200 functions to introduce a catholyte to the electrolyzer so that it can be reduced to produce a product. S200 is optional as the catholyte can be introduced with the anolyte, where the catholyte can cross-over through the membrane. S200 can include adding, feeding, supplying, and/or any other introduction of water in the catholyte flow path of the electrolyzer.

S200 can be performed by pumps (e.g., centrifugal pumps, diaphragm pumps, peristaltic pumps, etc.), valves (e.g., needle valves, solenoid valves, check valves, etc.), microfluidic devices, flow manifolds, and/or any other mechanisms (e.g., that enable or promote fluid flow or transport).

S200 can be performed continuously, intermittently, synchronously with other steps (for example, synchronously or contemporaneously with S100 or S300), asynchronously of other steps, and/or any other timing pattern.

The catholyte flow path can be a region of the electrolyzer for containing the catholyte. The catholyte flow path can be in fluid connection with the cathode and membrane/separator. The catholyte flow path can be a flow field, porous plate, and/or any other structure.

The catholyte is preferably water. The water (and/or other catholyte materials) can be in a liquid phase, a gas phase, and/or can have any suitable phase. However, the catholyte can include other suitable components (e.g., additives) and/or species (e.g., protic solvents, protic fluids, etc.).

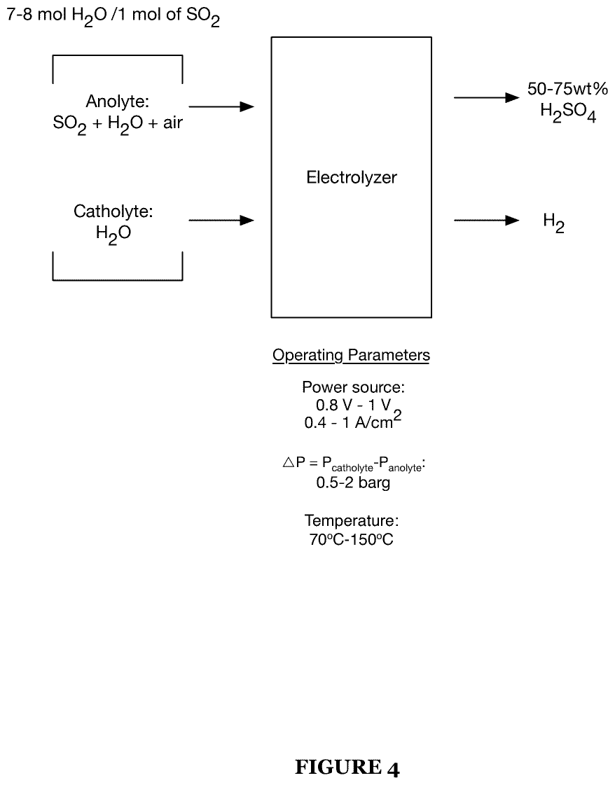

S100 and S200 are preferably (cooperatively) designed to control a total amount of water introduced to the electrolyzer relative to a total amount of sulfur (primarily in the form of SO₂), thereby maintaining a water balance (as shown for example in FIG. 4). The total amount of water introduced to the electrolyzer between the catholyte and anolyte is preferably approximately 7.5 mol of water (e.g., 7-8 mol) per mol of SO₂ to achieve a sulfuric acid concentration between 50 wt % and 80 wt %. However, a different mole ratio (e.g. 6:1, 7:1, 7.1:1, 7.2:1, 7.3:1, 7.4:1, 7.5:1, 7.8:1, 7.9:1. 8:1, 9:1, etc.) of water to SO₂ can be used to achieve different sulfuric acid concentrations and/or to change the current density, voltage, temperature, and/or other operation parameter(s) for electrolyzer operation (and thereby performance).

In one specific example, a water concentration between 20 mol % and 50 mol % was found to produce sulfuric acid with a target concentration (approximately 50-65 mol % sulfuric acid) using a target electric potential and electrolyzer temperature. In a second specific example, a water concentration between 10 mol % and 20 mol % was found to produce sulfuric acid with a target concentration (approximately 50-65 mol % sulfuric acid) using a target electric potential and electrolyzer temperature.

During operation, the water balance is preferably substantially constant, but can alternatively be variable (e.g., can vary as applied electric potential rises in constant current operation, can vary as current density changes in constant electric potential operation, etc.). In variants, the amount of water introduced in the cathode flow path or anode flow path can be modified (e.g., increased, decreased, etc.) to alter concentration of the sulfuric acid product (e.g., in a closed or open feedback loop). In a first example, sensors at an outlet of electrolyzer can measure sulfuric acid concentration and, responsive to the sulfuric acid concentration, the amount of water introduced in the electrolyzer can be increased or decreased (for example, by increasing or decreasing water stream flow rate in catholyte and/or anolyte, modifying a differential pressure to modify a water-crossover amount through the separator, etc.). In a second example, sensors measuring voltage or current density can register a signal that exceeds a threshold, resulting in a modification to an amount of water (for example, when current density is less than a threshold, potentially signifying increased ionic resistance due to degradation or catalytic active site blockage, more water can be introduced). The modification of the amount of water can be done in any suitable method (e.g., introduction with anolyte, with catholyte, modifying a differential pressure to change the amount of water crossover, etc.).

The method can optionally include introducing additive(s) with the catholyte and/or the anolyte. The additive(s) can be dissolved in the anolyte and/or catholyte (e.g., prior to introducing to the electrolyzer), introduced as a vapor or mist, introduced as a gas, introduced as a liquid, introduced with a carrier fluid, and/or can otherwise be introduced. In variants that include additives, the additive(s) (e.g., each additive, total additives, etc.) preferably make up between 0-15 wt % of the anolyte and/or catholyte solution. However, other additive concentrations could be used. In one example, the additives can include salts (e.g., potassium sulfate, sodium sulfate, lithium sulfate, ionic liquids, etc.) which can function to modify electrical conductivity. In a second example, the additives can include buffering agents (e.g., boric acid, phosphate-based buffers, etc.) which can function to control a pH of the catholyte or anolyte (inclusive of the products) and/or minimize pH fluctuations (e.g., to alter reaction efficiency, control cathode degradation, membrane degradation, anode degradation, housing degradation, etc.). In a third example, the additives can include surfactants (e.g., Triton X-100, Tween 20, sodium dodecyl sulfate, etc.) which can function to reduce bubble formation (e.g., on the cathode, on the anode, etc.), to improve reaction rates, and/or can otherwise function. In a fourth example, the additives can include chelating agents (e.g., ethylenediaminetetraacetic acid, citric acid, etc.) which can function to prevent buildup of metal ions (e.g., from dissolution of the housing, electrodes, manifolds, etc.). As a fifth example, the additives can include corrosion inhibitors (e.g., sodium phosphates, sodium molybdate, benzotriazole, etc.) which can function to protect the components of the electrolyzer from corrosion. As a sixth example, the additives can include catalytic promoters (e.g., cocatalysts; such as Co(II) salts, Co(III) salts, platinum group metal catalysts, platinum-based catalysts, iridium-based catalysts, vanadium pentoxide, etc.) which can function to improve a reaction rate and/or reaction efficiency. As a seventh example, the additives can include cleaning agents (e.g., O₂, hydrogen peroxide, etc.) which can function to prevent buildup of undesirable species (particularly but not exclusively sulfur or hydrogen sulfide) and associated resistance increases or electrolyzer degradation.

Operating the electrolyzer S300 functions to oxidize sulfur dioxide (in combination with water) into sulfuric acid and reduce water into hydrogen.

The electrolyzer can be operated continuously, intermittently, sporadically, in batches, and/or with any other operating frequency or timing. Controlling or changing operating parameters can occur in response to a signal, continuously, intermittently, and/or any other timing pattern. The electrolyzer can be operated in a constant electric potential mode (e.g., where a current or current density is modified to maintain a constant electric potential between the anode and the cathode), a constant current mode (e.g., where an electric potential can vary or be modified to maintain a constant current or current density between the anode and the cathode), and/or can be operated in any suitable manner.

In variants, operating the electrolyzer S300 can include maintaining a pressure differential S320; applying a voltage across the electrodes S340; and maintaining a temperature of the electrolyzer S360.

Maintaining a pressure differential S320 functions to control a relative pressure of anolyte and catholyte (e.g., across the separator), which can provide a technical advantage of controlling flow of anolyte and/or catholyte across the separator and/or membrane and/or controlling a reaction rate. S320 can be performed using pressure sensors, pumps, catholyte and anolyte valves, pressure regulators, and/or any other components.

Fluids within the catholyte flow path (e.g., the catholyte) are preferably at a higher pressure than fluids in the anolyte flow path. The pressure differential can cause water from the catholyte flow path to be forced or driven across the membrane of the electrolyzer, can hinder sulfur dioxide (or other anolyte components) from crossing over the membrane (e.g., thereby decreasing a potential for reduction of the sulfur dioxide to sulfur or hydrogen sulfide), and/or can otherwise affect the system operation.

The pressure differential between cathode and anode is preferably between 0.1 and 50 barg (e.g., 0.2 barg, 0.3 barg, 0.5 barg, 1 barg, 1.5 barg, 2 barg, 2.5 barg, 3 barg, 3.5 barg, 4 barg, 5 barg, 10 barg, 15 barg, 20 barg, 25 barg, 30 barg, 40 barg, 50 barg, values or ranges therebetween, etc.). The pressure differential can alternatively be less than 0.1 barg (e.g., the anolyte and catholyte can have substantially the same pressure across the membrane) or greater than 50 barg. In an illustrative example, a pressure differential of between approximately 0.5-1.5 barg can be used to achieve sulfuric acid at a desired concentration (approximately 50-65 mol % sulfuric acid, at least 50 mol %, etc.).

However, in some variants, the anolyte can alternatively have a higher pressure (e.g., so that excess/unreacted water can be pushed through the membrane and the membrane is effectively used to concentrate the sulfuric acid).

S320 can include maintaining a pressure differential by controlling catholyte pressure, anolyte pressure, oxidized anolyte (e.g., sulfuric acid) pressure, and/or the reduced catholyte partial pressure (e.g., hydrogen gas partial pressure). The pressure differential can be maintained by controlling flow rate of catholyte and anolyte; by pressurizing the reduced catholyte, anolyte, and/or catholyte; controlling a fluid pressure for the anolyte, catholyte, reduced catholyte, and/or oxidized anolyte; modifying a temperature of the anolyte, catholyte, oxidized anolyte, and/or reduced catholyte (e.g., in a substantially constant volume); and/or can otherwise be maintained.

S320 can include using pressure sensors to monitor catholyte pressure, anolyte pressure, H₂ pressure, pressure differential, and/or other suitable pressure. The method can include using feedback control loops to adjust pressures.

Applying a voltage across the electrodes S340 functions to electrically induce redox reaction. S340 can be performed by a power supply. During normal operation, the anode can be connected to the positive terminal of the power supply, and the cathode can be connected to the negative terminal of the power supply.

The voltage applied across the electrodes can be between 0V and 5V or any range or value therebetween (e.g., 0.1 volts, 0.2 volts, 0.3 volts, 0.4 volts, 0.5 volts, 0.6 volts, 0.7 volts, 0.8 volts, 0.9 volts, 1 volt, 1.5 volts, 2 volts, 2.5 volts, 3 volts, 3.5 volts, 4 volts, 4.5 volts, 5 volts). In an illustrative example, the inventors determined that an applied voltage between 0.8 volts and 1 volt can produce sulfuric acid at a desired concentration (approximately 50-65 mol % sulfuric acid) while achieving energy-use targets.

The current density of the electrodes (anode, cathode) is preferably between 0.1 A/cm² and 5 A/cm² or any range or value therebetween (e.g., 0.1 A/cm², 0.2 A/cm², 0.3 A/cm², 0.4 A/cm², 0.5 A/cm², 0.6 A/cm², 0.7 A/cm², 0.8 A/cm², 0.9 A/cm², 1 A/cm², 2 A/cm², 3 A/cm², 4 A/cm², 5 A/cm²). The current density can alternatively be less than 0.1 A/cm² or greater than 5 A/cm². In an illustrative example, a current density between 0.4 A/cm² and 0.6 A/cm² has been found to successfully generate sulfuric acid at a desired concentration (approximately 50-65% sulfuric acid) while achieving energy-use targets.

Maintaining a temperature of the electrolyzer S360 can function to control the electrolyzer temperature to achieve a target reaction rates, prevent material degradation, reduce a risk of separator dehydration, and/or any other suitable temperature control objectives.

The temperature of the electrolyzer can be between 60° C.-200° C. or any range or value therebetween (e.g., 80° C., 100° C., 150° C., 175° C., 120-150° C., 90-180° C., 60-80° C., 70-90° C., 60-100° C., etc.). The temperature can alternatively be less than 60° C. or greater than 200° C.

The temperature setting of the electrolyzer can be dependent on the electrolyzer materials. In a first example, the temperature can be between 60° C. and 90° C. or any range or value therebetween (e.g., 65° C., 70° C., 75-85° C.), particularly but not exclusively for an electrolyzer with a Nafion membrane. In a second example, the temperature can be between 90° C. and 200° C. or any range or value therebetween (e.g., 120° C., 150° C., 160-180° C.) for an electrolyzer with a PBI (or other non-nafion) membrane.

S360 can include using temperature sensors to monitor temperature. The temperature can be changed to modify a resulting sulfuric acid concentration (e.g., based on sulfuric acid concentration monitoring).

However, operating the electrolyzer S300 can be otherwise performed.

Optionally processing the products S400 functions to modify or alter properties of resultant hydrogen gas and/or sulfuric acid. S400 can be performed continuously, in batches, and/or with any suitable timing (e.g., concurrently with or delayed relative to S100, S200, S300, and/or other instantiations of the method).

S400 can include treating, refining, preparing, concentrating, pressurizing, filtering, and/or otherwise processing the products.

In variants, S400 can include concentrating sulfuric acid, purifying H₂, and filtering the sulfuric acid.

S400 can include purifying the H₂. The purification can function to remove impurities (particularly sulfur containing impurities such as SO₂, SO₃, H₂S, etc.) of the hydrogen gas and isolate H₂. The purification can be performed by pressure swing adsorption units, membrane separation systems, molecular sieve filters, cryogenic distillation systems, catalytic purifiers, absorption systems, and/or any other purification systems.

Concentrating sulfuric acid functions to increase the concentration of the sulfuric acid for use in various applications. Concentrating sulfuric acid can be performed by a heating system, distillation columns, filters, dialysis system, and/or any other system.

Concentrating sulfuric acid can involve heating the sulfuric acid to evaporate water. In one example, the heat for water evaporation can come from heat used for roasting sulfur to produce sulfur dioxide. In another example, solar concentrator heat can be used to evaporate water. However, heat for removing water can otherwise be provided.

The sulfuric acid can be concentrated to any concentration greater than the H₂SO₄ concentration output by the electrolyzer. The H₂SO₄ concentration is preferably concentrated to between 50% and 100% or any range or value therebetween (e.g., 50%, 55%, 60%, 65%, 70%, 80%, 90%, 92%, 95%, 98%, 99%, 99.9%, 100%, etc.).

In a first variant, concentrating sulfuric acid can include heating the sulfuric acid solution to evaporate out the water at temperatures greater than or equal to 300° C. (e.g., 300° C., 310° C., 320° C., 330° C., 340° C., 350° C., 360° C., 370° C., 380° C., 390° C., 400° C.). In a second variant, concentrating sulfuric acid can include vacuum distilling the sulfuric acid solution by filling a chamber with the solution, reducing the pressure of the chamber, optionally heating the chamber, and removing the water vapor. In a third variant, concentrating sulfuric acid can include using water-selective membranes to separate the water from sulfuric acid.

Filtering the sulfuric acid can function to remove impurities from the sulfuric acid. Filtering the sulfuric acid can be performed by distillation columns, ion-exchange columns, filtration systems, absorption towers, and/or any other filtering mechanisms.

However, S400 can be otherwise performed.

Optionally using the products S500 functions to utilize the hydrogen gas and/or sulfuric acid for various applications. H₂ and H₂SO₄ are preferably used cooperatively (e.g., directly or indirectly used to produce a single set of outputs), but can alternatively be used for separate applications.

S500 can include: making phosphate fertilizer, using the products in a hydrogen fuel cell, refining mineral(s), refining hydrocarbon sources (such as petroleum), synthesizing chemical products, and/or other suitable processes.

S500 can include making phosphate fertilizer. In a first specific example, the hydrogen can be used to form ammonia (e.g., via a Haber-Bosch process) and the sulfuric acid can be used to digest a phosphate ore to produce phosphoric acid (where the phosphoric acid and ammonia can be combined to form an NP fertilizer). In a second specific example, the hydrogen and sulfuric acid can be used in a manner as described in U.S. patent application Ser. No. 18/598,324 titled ‘SULFUR DIOXIDE DEPOLARIZED ELECTROLYSIS AND ELECTROLYZER THEREFOR’ filed 7 Mar. 2024 or U.S. patent application Ser. No. 19/052,739 titled ‘SYSTEMS AND METHODS FOR INCREASED SULFURIC ACID CONCENTRATION FROM SULFUR DIOXIDE DEPOLARIZED ELECTROLYSIS AND USES THEREOF’ filed 13 Feb. 2025, each of which is incorporated in its entirety by this reference.

S500 can include using the products in hydrogen fuel cells (e.g., using the output hydrogen as fuel for hydrogen fuel cells to produce energy or electricity).

S500 can include using the products for mineral refining. The products can function to facilitate the extraction, purification, and/or processing of ore (e.g., nickel extraction from nickel laterite ore, lithium extraction from lithium ore, etc.). For example, H₂SO₄ can be used for leaching and/or organic species removal and H₂ can be used for reduction (e.g., reducing a metal oxide to base metal).

S500 can include refining petroleum and/or other hydrocarbon sources. The function can include using sulfuric acid for alkylation and hydrogen for hydrocracking (and/or other hydrotreating processes) in petroleum processing.

S500 can include synthesizing chemical products. Examples of chemical products can include, but are not limited to, dyes, explosives, detergents, ammonia, food additives, biologics, drug products, hydrocarbons, syn gas, and/or any other chemical products. The products can be otherwise utilized.

However, using the products S500 can be otherwise performed.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

We claim:

1. A method comprising:
introducing a sulfur dioxide mixture in an anolyte flow path of an electrolyzer wherein the sulfur dioxide mixture comprises gaseous sulfur dioxide and between 5 mol % and 50 mol % gaseous water;
introducing liquid water in a catholyte flow path of the electrolyzer;
maintaining a pressure differential between the catholyte flow path and the anolyte flow path between 0.1 and 2 barg, wherein the pressure differential forces the liquid water through a membrane and into the catholyte flow path; and
applying an electrical potential across an anode and a cathode of the electrolyzer, such that the sulfur dioxide oxidizes to produce sulfuric acid and the water is reduced to produce hydrogen gas, wherein the electrical potential is between 0.8 volts and 1 volt, wherein a current density at the anode and cathode is between 0.4 A/cm² and 1 A/cm²;
wherein the produced sulfuric acid has a concentration of at least 60 wt % at an anolyte outlet of the electrolyzer, wherein a total water content introduced between the gaseous water and the liquid water is between 6 and 8 moles of water per mole of gaseous sulfur dioxide.

2. The method of claim 1, further comprising maintaining a temperature of the electrolyzer between 60° C. and 100° C.

3. The method of claim 1, wherein the electrolyzer comprises a platinum-group metal catalyst.

4. The method of claim 1, wherein the membrane is made of a sulfonated polytetrafluoroethylene fluoropolymer.

5. A method comprising:
introducing sulfur dioxide in an anolyte flow path of an electrolyzer;
applying electricity to the electrolyzer, such that the sulfur dioxide in combination with water oxidizes to produce sulfuric acid;
wherein a total amount of water introduced to the electrolyzer in the anolyte flow path and the catholyte flow path defines a water balance that yields sulfuric acid comprising a concentration of at least 50 wt % at an outlet of the electrolyzer.

6. The method of claim 5, further comprising maintaining a pressure differential between a catholyte and an anolyte at a value between 0.1 barg and 2 barg.

7. The method of claim 5, further comprising introducing water in the anolyte flow path with the sulfur dioxide, wherein a concentration of the water in the anolyte flow path is between 5 mol % and 20 mol %.

8. The method of claim 5, further comprising measuring the concentration of the sulfuric acid, wherein the total amount of water introduced to the electrolyzer is modified depending on the concentration of the sulfuric acid.

9. The method of claim 5, wherein a current density of the electricity is between 0.4 A/cm² and 1 A/cm².

10. The method of claim 5, wherein the electricity induces an electric potential between 0.8 and 1 volts.

11. The method of claim 5, wherein the electrolyzer comprises a platinum-group metal catalyst.

12. The method of claim 5, wherein the electrolyzer comprises at least one catalyst selected from a list consisting of: metal oxides, ruthenium oxide, palladium oxide, iridium oxide, titanium oxide, nickel oxide, iron oxide, carbon nanotubes, graphene, graphite, polymers, platinum-based materials, cobalt-based materials, nickel-based materials, perovskites, transition metal phosphides, transition metal chalcogenides, metal-organic frameworks, and covalent organic frameworks.

13. The method of claim 5, wherein the electrolyzer comprises a membrane separating the anolyte flow path from the catholyte flow path, wherein the membrane is made of a sulfonated polytetrafluoroethylene fluoropolymer.

14. The method of claim 13, further comprising maintaining a temperature of the electrolyzer between 80° C. and 100° C.

15. The method of claim 5, wherein the electrolyzer comprises a membrane separating the anolyte flow path from the catholyte flow path comprising at least one of: polybenzimidazole (PBI), sulfonated polybenzimidazole (s-PBI), sulfonated Diels-Alder polyphenylene (SDAPP), silicon carbide, polytetrafluoroethylene (PTFE), or glass.

16. The method of claim 15, wherein the electrolyzer is maintained at a temperature that depends on the membrane.

17. The method of claim 16, wherein the temperature is between 90° C. and 180° C.

18. The method of claim 5, wherein maintaining the pressure differential comprises controlling a pressure of the sulfur dioxide introduced in the anolyte flow path, controlling a pressure of the liquid water introduced in the catholyte flow path, controlling a pressure of sulfuric acid, and controlling a partial pressure of generated hydrogen.

19. The method of claim 5, further comprising concentrating the sulfuric acid to greater than 90 wt % sulfuric acid.

20. The method of claim 5, further comprising utilizing the sulfuric acid to make phosphate fertilizer.
